(19) United States
(12) Patent Application Publication
(10) Pub. No.: US 2005/0123682 A1
(43) Pub. Date: Jun. 9, 2005

(54) Method and device for forming a plastic coat on a surface

(76) Inventors: Jacques Thomaset, Neuvecelle (FR); Hugues-Vincent Roy, St-Legier/La Chiesaz (CH)

Correspondence Address: NIXON & VANDERHYE, PC, 1100 N GLEBE ROAD, 8TH FLOOR, ARLINGTON, VA, 22201-4714, US

(21) Appl. No.: 10/499,490

(22) PCT Filed: Dec. 16, 2002
(86) PCT No.: PCT/CH02/00700

(30) Foreign Application Priority Data
Dec. 21, 2001 (CH) 2361/01
Mar. 26, 2002 (CH) 521/02

(51) Int. Cl. B05D 3/12

(52) U.S. Cl. 427/355; 118/200; 264/129

(57) ABSTRACT

The invention relates to a method of manufacturing a layer (7) over a surface (6) from a liquid or viscous plastic (8) which solidifies once the layer (7) is formed, characterized in that the plastic (8) is introduced in liquid or viscous form into a reservoir (2) of variable volume, at least part of the inner wall of which is defined by a portion of the said surface (6); the reservoir (2) and the surface (6) are moved relative to each other while simultaneously decreasing the volume of the reservoir (2) so as to compress the plastic (8) and make it flow through a passage (9) connecting two surface portions placed respectively inside and outside the reservoir (2), the rate of flow of the plastic (8) through the passage (9) being chosen so as to form a layer (7) over one of the said surface portions (6) whose thickness (e) is less than the height of the said passage (E). The invention also relates to a device using the method described above and to the objects obtained by this same method.

### FIELD OF THE INVENTION

The present invention relates to a method and to a device for forming a layer over a surface from a liquid or viscous composition.

The method and the device are particularly, although not exclusively, intended for manufacturing plastic objects or for applying (a) coating(s) to the inside or outside of packagings.

The invention also relates to an object obtained by the above method.

### PRIOR ART

Currently, the coating of walls of objects or the production of plastic walls is carried out using one of the following methods:
The injection moulding method consists in injecting the plastic in the liquid state into the cavity of a closed mould. As it cools, the plastic solidifies and retains the geometry defined by the cavity of the mould.
The compression moulding method consists in feeding the plastic in the liquid state into an open mould. On closing the mould, the plastic flows and fills the cavity of the mould. As it cools, the plastic solidifies and retains the geometry defined by the cavity of the mould.
The method of extruding a hollow body consists in extruding a parison made of molten plastic, then in blowing the parison inside a mould so as to adopt the geometry thereof. On contact with the mould, the molten plastic is cooled and it solidifies.
The flat extrusion method for film, sheet or plate consists in continuously feeding a film of variable thickness made of plastic in the molten state and in cooling this film on cooling rolls.
The coating or film-coating method consists in continuously extruding a plastic film which is deposited on a substrate as it runs past.
The bubble extrusion method consists in continuously feeding a tubular film made of molten plastic, then in blowing and stretching the film in air.
The method of extruding a tube or a profiled section consists in continuously feeding the molten plastic, in making it pass through a sizing die then in cooling it so that it solidifies.
The method of coating a tube or a cable consists in covering the object which runs past with a layer of plastic, and in solidifying this layer by cooling the plastic in water.
The thermoforming method consists in heating a plastic sheet to a temperature below the melting point, then in deforming this sheet by pressure or vacuum in a mould.
The method of biaxial orientation by blow moulding consists in manufacturing hollow bodies starting from an injection moulded preform. The preform is heated to a temperature below the melting point of the plastic then stretched and blown into a mould. The plastic solidifies on contact with the mould.

The subject of the present invention is a method and a device for implementing the said method making it possible to produce either plastic coatings, or walls of objects made of plastic.

### SUMMARY OF THE INVENTION

The present invention relates to a method of manufacturing a layer over a surface from a liquid or viscous plastic which solidifies once the layer is formed, characterized in that the plastic is introduced in liquid or viscous form into a reservoir of variable volume, at least part of the inner wall of which is defined by a portion of the said surface; the reservoir and the surface are moved relative to each other while simultaneously decreasing the volume of the reservoir so as to compress the plastic and make it flow through a passage connecting two surface portions placed respectively inside and outside the reservoir, the rate of flow of the plastic through the passage being chosen so as to form a layer over one of the said surface portions whose thickness is less than the height of the said passage.

The invention also relates to a device for manufacturing a layer over a surface operating according to the method described above, characterized in that it comprises:
a surface to be coated,
a reservoir of variable volume, at least part of the inner wall of which is defined by a portion of the said surface,
a passage connecting two portions of the surface that are placed respectively inside and outside the reservoir, the height of the passage constituting an upper limit of the thickness of a layer to be deposited,
means for producing relative movement of the reservoir with respect to the surface,
means for decreasing the volume of the reservoir during its relative movement.

The invention also relates to an object obtained according to the method described above, characterized in that it comprises a layer consisting of a plastic which was initially liquid or viscous and which solidified once it was deposited, the inner and outer faces of the layer having different roughnesses.

### FIELD OF APPLICATION OF THE INVENTION

The invention may be used for a very great variety of applications. A point common to these is the initially liquid or pasty state of the plastic forming the layer. Plastics can be differentiated depending on whether they cure or remain liquid or pasty after forming the layer (greasing, lubrication). The majority of applications relates to plastics which cure after deposition. Among this last category, mention may especially be made of plastics which harden by cooling after deposition (thermoplastic polymers), plastics which harden after curing (thermosetting polymers, varnishes), plastics which harden by evaporation (water- or solvent-based paints), and plastics which cure by chemical reaction (adhesives).

Coating Materials

The method of forming a layer according to the invention makes it possible to produce plastic objects or coatings with very diverse properties. By way of non-limiting example, the following polymers may be used:
Polyolefins: PP, EPDM, PE, EVA, EVOH, EEA, EMA, PB, ionomers
Vinyl polymers: PVC, C-HD-PE, EVA/VC, VC/VDC/AN, VC/MA
Styrene polymers: PS, SMS, SAN, SB, ABS, ASA
Fluoropolymers: PTFE, FEP, ETFE, PCTFE, PVF, PVDF
Polyamides: PA-6, PA-6,6, PA-4,6, PA-12, PA-11, PA-6/12
Polyesters: PC, PET, PBT, PEN, LCP
Polymethyl methacrylates (PMMA)
Polyacetals (POM)
Polyurethanes
Polylactic acids (PLA)
Polyacrylonitriles
Polyarylethers and polyaryletherketones
Polyimides
Phenol-formaldehyde resins
Urea-formaldehyde resins (aminoplastics)
Melamine-formaldehyde resins
Unsaturated polyester resins
Silicone resins
Epoxide resins
Crosslinked polyurethanes
Polymer blends or alloys.
   Feeding into the Device

The plastic may be fed in the liquid, pasty or solid state into the coating device. In the particular case where it is fed in the solid state, the coating device will be used in order to melt the plastic and make it liquid or pasty before coating.

The device can be fed according to known techniques for filling a cavity, that is to say:
gravity feed (solids or liquids)
pump feed
screw feed
(liquid) injection feed
feed by manual or automatic transfer
feed by an extruder or an injection moulding machine.

This list is not exhaustive.

Operational Procedure

The operating procedure must be suitable for the polymer used in order to form the coating. Depositing a thermoplastic requires prior heating of the polymer in order to make it fluid or pasty in the coating device, then cooling of the polymer when the coating is formed. The coating device according to the invention may be heated or cooled depending on the thickness of the coating, the geometry of the part and the operating conditions.

Depositing a thermosetting polymer necessarily involves curing the polymer after deposition so as to allow crosslinking. The deposition can be carried out hot or cold depending on the product deposited, the geometry of the part and the operating conditions (deposition rate).

The deposition of a paint according to the invention involves an evaporation phase after deposition. Furnaces, hoods or other equipment used to pick up the fumes and accelerate the evaporation process may be coupled to the coating device according to the invention.

Production of Objects or Deposition of Coatings made of Plastic

The production of objects or the deposition of coatings made of a thermoplastic according to the invention requires heating the polymer to a temperature higher than its melting point in order to allow the plastic to flow in the coating device. In general, the conversion temperature is at least higher than the melting point plus 10 to 20° C. For polymers having a very narrow melting peak, the conversion temperature may be fairly close to the melting point. When the layer is deposited on the wall, it solidifies on cooling. The coating device may be heated or cooled.

Production of Objects made of Plastic

The production of a part made of plastic with the device according to the invention may be defined as the coexistence of at least two phases in some cases, one a coating phase likened to the extrusion method, the other a compression moulding phase likened to the injection or compression moulding method. In this embodiment, the invention combines the advantages of an extrusion method and of a moulding method. In particular, the method according to the invention makes it possible to have a low and substantially constant pressure drop during the coating phase and to guarantee high accuracy and to maintain the appearance during the compression phase.

The invention makes it possible to produce plastic objects of variable thickness, between 50 microns and 10 mm and preferably between 0.25 mm and 2.5 mm. Note that a thickness of less than 50 microns can also be envisaged. Depending on the thickness of the part, grades of varying fluidity will be chosen. For a very small desired wall thickness, a polymer with a high melt flow index will be preferred while a viscous product will preferably be chosen for a thick wall.

The invention makes it possible to produce plastic objects having a thin (less than 0.5 mm) wall with side walls having a length greater than 400 mm, and to do so with very low material pressures in the device. The invention makes it possible to obtain dimensions of high accuracy for that portion of the part produced by compression moulding.

The invention also makes it possible to produce plastic objects having a thick (greater than 5 mm) wall with side walls having a length greater than 1 m, and do so with low material pressures in the device. The invention makes it possible to obtain dimensions of high accuracy for that portion of the part produced by compression moulding.

The method according to the invention makes it possible to produce novel objects that would be difficult or impossible to produce with the known methods. For example, the method makes it possible to manufacture a cylindrical casing having a depth of 60 cm, a diameter of 10 cm and a wall thickness of 0.5 mm, or else a flexible bag having a thickness of 0.3 mm, having a bottom whose thickness is 1 mm.

The objects produced according to the invention generally have different inner and outer surface properties in that part of the object produced by coating.

The inner coating device makes it possible to obtain objects whose outer surface is of high quality (optical properties, appearance, roughness, etc.), the outer face of the object being in contact with the inner wall of the device. The inner face of the object is cooled by convection with a gas (air, nitrogen).

The outer coating device makes it possible to obtain objects whose inner surface is of high quality (optical properties, appearance, roughness, etc.), the inner face of the object being in contact with the outer wall of the device. The outer face of the object is cooled by convection with a gas (air, nitrogen).

Production of Plastic Coatings

The coating method according to the invention may be used to coat metal, glass, plastic, board or paper surfaces with a thermoplastic polymer.

For example, the invention makes it possible to deposit a thermoplastic coating on the inner or outer surfaces of a tube or a profiled section. The thickness of the coating may vary between 0.05 mm and 10 mm, and preferably between 0.2 mm and 2 mm.

The invention makes it possible to completely or partially coat the surface of an object (film, sheet, tube, profile, object).

The coated object may be heated before depositing the coating or during the coating.

Prior treatment of the surface to be coated may be carried out before deposition. Among the prior treatment, mention may be made of:
chemical treatments
heat treatments
physical treatments
mechanical treatments.

The invention and detailed examples according to the invention will be described hereinbelow by means of the following figures:

### BRIEF DESCRIPTION OF THE DRAWINGS

FIG. 1 shows a sectional view of the device which is produced in a plane parallel to the direction of relative movement of the device and of the part to be coated.

FIG. 2 shows an enlargement of the device of FIG. 1 in the area of the passage.

FIG. 3 illustrates the device of FIG. 1 as it moves.

FIG. 4 is a sectional view of another variant of the device according to the invention.

FIGS. 5 to 9 illustrate various operating steps of another variant of the device.

FIGS. 10 to 15 illustrate various operating steps of another variant of the device.

FIGS. 16 and 17 illustrate a device for manufacturing multilayer objects.

FIG. 18 shows an object obtained by means of the device of FIGS. 16 and 17.

FIGS. 19 and 20 illustrate a device for manufacturing blown objects.

FIGS. 21 to 28 illustrate a device for the inner coating of a tubular body.

FIG. 29 illustrates a device for the outer coating of a tubular body.

FIG. 30 illustrates a device identical to that of FIG. 29, which however further comprises means to form a shoulder and a tube head.

FIG. 31 illustrates a device for manufacturing a tube.

FIG. 32 illustrates a device in particular making it possible to create a protuberance.

FIG. 33 illustrates a device in particular making it possible to create a protuberance in the form of a double lug.

FIG. 34 shows an object obtained with the device of FIG. 33.

FIG. 35 illustrates a device operating by fluid injection.

FIGS. 36 and 37 illustrate two possibilities for forming the upper face of a layer.

FIG. 38 illustrates a device for the inner coating of curved objects.

FIGS. 39, 40a and 40b show various objects obtained with the device according to the invention.

FIGS. 41 and 42 show objects obtained with the device according to the invention which include regions of higher stiffness.

FIG. 43 illustrates a device for the simultaneous manufacture of a multilayer object.

FIG. 44 illustrates another variant of a device for the simultaneous manufacture of a multilayer object.

FIG. 45 illustrates a device including a system for injecting plastic into the reservoir.

FIGS. 46 and 47 show the operation of a device including an injection system.

FIGS. 48 and 49 show the operation of another device including an injection system.

FIGS. 50 and 51 show, very schematically, a system for injecting plastic used for a plurality of coating devices.

FIG. 52 illustrates a plurality of coating devices using a single drive system.

FIGS. 53 to 55 illustrate a plurality of coating devices placed on a rotary system.

FIGS. 56 and 57 illustrate the combination of an injection device and of a device according to the invention.

FIG. 58 illustrates the combination of an extrusion device and a device according to the invention.

FIGS. 59 to 62 illustrate the manufacture of multilayer objects.

FIGS. 63 to 66 illustrate the manufacture of multilayer objects.

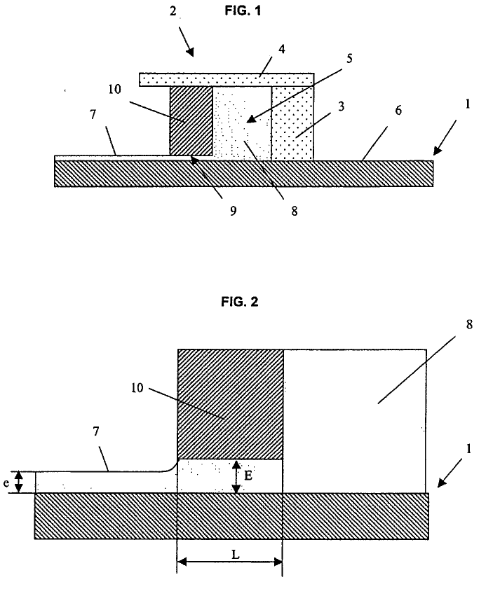

The inventive concept is illustrated in FIGS. 1 and 2 which schematically show a first embodiment.

A part 1 to be coated comprises the surface 6 over which the plastic 8 contained in the reservoir 2 is deposited. The cavity 5 of the reservoir 2 is delimited by the surface 6 to be coated, two stationary walls 3, 4 and a wall 10 adjacent to a passage 9 through which the plastic 8 emerges from the reservoir 2 in order to form a layer 7 of plastic. The reservoir 2 may have two side walls, not visible in FIG. 1. The passage 9 is placed between the wall 10 and the part 1 to be coated. It is characterized by a height E and a length L. The layer 7 is formed behind the passage 9, while the reservoir 2 moves relative to the part 1 to be coated (the relative movement takes place towards the right-hand side of FIG. 1). The height e of the layer 7 is defined by the distance between the wall 10 and the part 1 to be coated.

FIG. 2 is a schematic representation in the area of the passage 9. It should be noted that, preferably, the thickness e of the layer 7 is less than the height E. The deposited thickness e essentially depends on the height E, the length L, the relative speeds between the wall 10 adjacent to the passage and the part 1 to be coated, the pressure in the cavity and the rheological properties of the plastic 8.

Initially, the plastic 8 in the liquid or pasty state fills the cavity 5. The surface 6 to be coated and the reservoir 2 move relative to each other during the coating operation. The term relative movement should be understood to mean that the surface 6 to be coated may be stationary and the reservoir 2 may be moved or vice-versa or that the surface 6 to be coated and the reservoir 2 may be moved. The plastic 8 escapes from the cavity 5 by virtue of the combined action of the movement of the part 1 to be coated which drags the plastic 8 on contact, and of the pressure in the cavity 5 created by bringing together the wall 10 adjacent to the passage and the wall 3 which is opposite thereto. In fact, in general, the plastic 8 inside the cavity 5 is not necessarily pressurized exclusively by the movement of the wall 10 adjacent to the passage and the wall 3 which faces it, but by the relative movement of any wall forming the cavity 5 and making it possible to reduce the volume of the said cavity.

It is interesting to note the advantage of the coating device according to the invention for producing very thin to very thick layers, with plastics having very different rheological properties. Thus, when the plastic 8 is very liquid or when the opening is large, a low pressure can be used in the cavity (in some cases, zero pressure), the plastic 8 being dragged out of the cavity 5 only by the movement of the surface 6 to be coated. On the other hand, when the plastic 8 is highly viscous or when the height of the passage 9 is low, pressure is needed so that the plastic 8 escapes from the cavity 5.

It is also interesting to note the effect of various parameters on the thickness of the coating. Thus, with a minimum pressure in the cavity 5, the thickness e of the layer 7 illustrated in FIG. 2 is less than the height E of the passage 9. In general, the thickness e is greater than half the height E. By increasing the pressure in the cavity 5, it is possible to create a thickness e greater than the height E since the pressure in the cavity 5 creates a flow of the plastic 8 out of the cavity 5 which is superimposed on the flow created by the relative movement of the surface 6 to be coated and of the reservoir 2. The height E makes it possible to adjust the deposited thickness e, an increase in the height E leading to a greater coating thickness e. The length L of the passage 9 makes it possible to absorb pressure fluctuations in the cavity 5 without altering the deposited thickness e. The dependence of the rheological properties of the plastic 8 on the parameters of the method such as the pressure in the cavity 5 or the rate of deposition, and more generally, on the design of the device, should also be noted.

The height E of the passage 9 is not necessarily constant over the length L, as shown in FIG. 2. The height E may increase or decrease from the cavity 5. The height E may also have sudden variations over the length L of the passage 9, such as steps, which may be used to absorb high pressure variations in the cavity 5 without altering the thickness e of the layer 7.

When the thickness e of the layer 7 is less than the height E, the length L does not necessarily define the distance beyond which the layer 7 of thickness e is formed. Also, when the thickness e is less than E, the length L may extend above the layer 7 of thickness e.

The device may be operated by controlling the movement rates or the pressures. For example, it is possible to adopt the following drive mode:
the wall 10 adjacent to the passage may be moved and driven at speed
a backpressure is applied to the opposite wall 3 in order to adjust the pressure in the cavity 5.

Another drive example is as follows:
the part 1 to be coated is driven at speed
the wall 10 adjacent to the passage and its opposite wall 3 are driven under pressure.

Air or liquid may exert pressure on the layer 7 once it is formed in order to improve contact between the layer 7 and the part 1 to be coated, to prevent the layer 7 detaching or to ensure proper removal of heat.

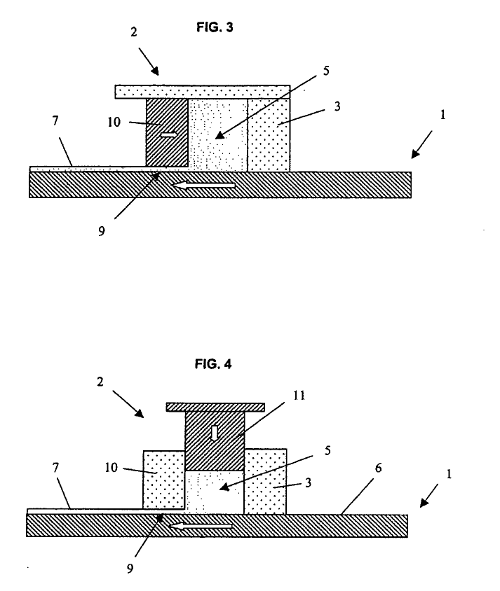

FIG. 3 indicates the relative movements between the various parts forming the coating device as described in FIG. 1 by considering a marker carried by the wall 3 opposite the wall 10 adjacent to the passage. The part 1 to be coated moves relative to the wall 3 without the plastic 8 contained in the cavity 5 being able to escape between the part 1 to be coated and the wall 3. The latter moves relative to the wall 10 adjacent to the passage so as to keep the plastic 8 inside the cavity 5 under pressure as the cavity 5 empties, and so as to control the thickness e of the layer 7.

FIG. 4 is a schematic representation of the coating device according to a second variant which, however, has several points in common with the previous variant. For this reason, the same numerical references will be used for the parts having the same function. Moreover, this simplification will be used with all variants of the invention explained below.

The reservoir 2 is at least formed by a portion of the surface 6 to be coated, two stationary walls 10, 3, one 10 of which forms the wall adjacent to the passage 9, and a moveable wall 11 capable of moving perpendicular to the surface 6 to be coated. The reservoir may have two side walls (not illustrated). By considering a marker carried by a stationary wall 3, the part 1 to be coated moves relative to the stationary wall 3 without the plastic 8 contained in the cavity 5 being able to escape between the part 1 to be coated and the stationary wall 3. The moveable wall 11 acts as a piston making it possible to create a pressure in the cavity 5.

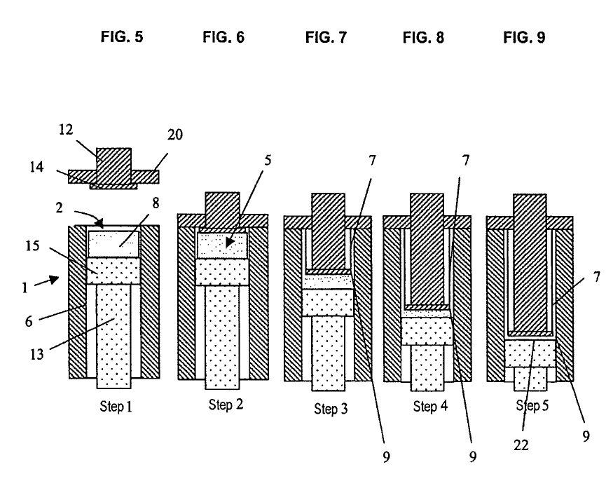

FIGS. 5 to 9 show an exemplary device which can be used for manufacturing hollow plastic objects or for the inner coating of hollow objects. The device has two pistons 12, 13 facing each other and sliding inside the space formed by the part 1 to be coated. A lid 20 may be added so as to obtain a suitably closed reservoir 2. The passage 9 is formed between the end 14 of the upper piston 12 and the part 1 to be coated.

FIG. 5 shows the reservoir 2 being filled with plastic 8.

FIG. 6 shows the device being closed and the plastic 8 being pressurized in the reservoir 2 so as to form the first end of an object or of a coating 7.

FIG. 7 shows the formation of the layer 7 created by the relative movement between the reservoir 2 and the part 1 to be coated. The lower piston 13 maintains a pressure in the cavity 5 while the layer 7 is formed.

FIG. 8 shows the formation of the object or of the coating at a more advanced stage. It will be noted that the amount of plastic 8 in the cavity 5 has decreased.

FIG. 9 shows the last step in forming the object or the coating 7. When an object is produced, the plastic 8 compressed between the ends 14, 15 of the pistons 12, 13 forms the bottom 22 of the object.

At this stage, it will be noted that the cross section of the end 14 of the upper piston 12 is less than the internal cross section of the part 1 to be coated. More exactly, the distance between the outer edge of the end 14 of the upper piston 12 and the inner wall of the part 1 to be coated corresponds to the height E of the passage 9.

On the other hand, the cross section of the end 15 of the lower piston 13 is substantially equal to the internal cross section of the part 1 to be coated. In any event, the plastic 8 must not be able to flow between the end 15 of the lower piston 13 and the inner wall of the part 1 to be coated.

As illustrated with this example, the cross section of the end 14 of the upper piston 12 is greater than the cross section of the rod of the said piston 12. This configuration has certain advantages. In particular, it makes it possible to considerably reduce the contact time between the upper face of the layer 7 once it is formed with the wall of the reservoir which is adjacent to the passage, it then being possible for the layer to solidify without being subject to unwanted friction of the wall adjacent to the passage. Furthermore, it is possible to benefit from the space generated between the rod of the upper piston 12 and the layer 7 formed by injecting a gas making it possible to propel the upper piston.

To manufacture an object made of a thermoplastic, the object is then at least partially cooled in the device before being removed therefrom.

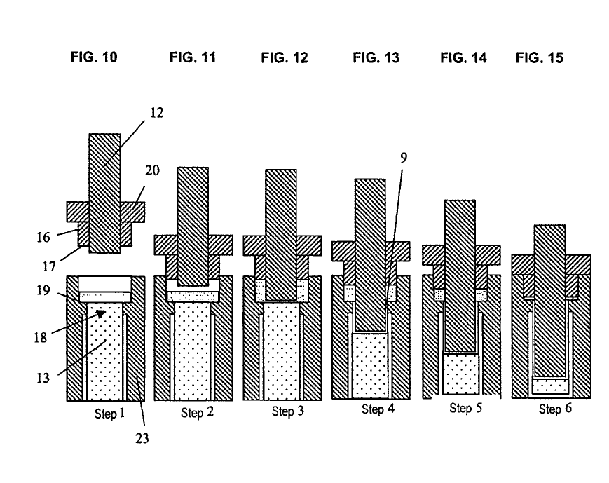

FIGS. 10 to 15 show an exemplary outer coating device which can be used for manufacturing thermoplastic objects. The device at least consists of three pistons 12, 13, 16 sliding inside a hollow body 23 which comprises a collar 19 placed in the upper part of its cavity, the internal cross section of the collar 19 being greater than the cross section of the upper piston 12, the opening formed between the collar 19 and the upper piston 12 forming the passage 9.

The upper piston 12, in its lower part, is surrounded by an annular piston 16 which is stationary or slides in a sealed manner around the latter.

FIG. 10 shows the reservoir 2 being filled with plastic 8.

FIG. 11 shows the device being closed.

FIG. 12 shows the plastic 8 being pressurized in the reservoir 2 and the first end of the object being formed around the end of the upper piston 12. It will be noted that, in this example, the end 14 of the upper piston 12 has a cross section identical to that of the rod of the said piston 12. The plastic 8 is compressed by bringing the end 17 of the annular piston 16 closer to the collar 19.

FIG. 13 shows the formation of the layer 7 created by the relative movement between the reservoir 2 and the upper piston 12. The annular piston 16 maintains a pressure in the cavity 5 while the layer 7 is formed.

FIG. 14 shows the formation of the object at a more advanced stage. It will be noted that the amount of plastic 8 in the cavity 5 has decreased.

FIG. 15 shows the last step in formation of the object. The material compressed between the annular piston 16 and the collar 19 may be preserved with the object, in this way forming an upper border.

Alternatively, this border may be removed once the object is taken from the device.

To manufacture a part made of a thermoplastic, the part is then cooled at least partially in the device before being removed.

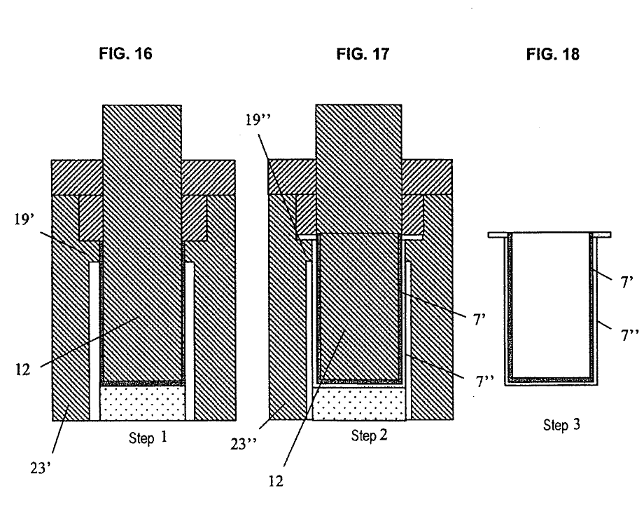

FIGS. 16 to 18 illustrate the manufacture of a plastic object having two layers 7′, 7″ with an outer coating device. The principle illustrated in FIGS. 16 to 18 may also be used to manufacture a multiple-material object (glass-plastic, aluminium-plastic, paper-plastic, plastic-plastic, etc.).

FIG. 16 illustrates the formation of the first layer 7′ of the plastic object in a first coating device.

FIG. 17 illustrates the formation of the second layer 7″ in a second coating device. To do this, after having formed the first layer 7′ in the device of FIG. 16, the object is inserted into the second device which is characterized by a collar 19″ having an internal diameter greater than that of the collar 19′ of the first device. The second layer is then formed using a method identical to that used for the first layer 7′.

FIG. 18 illustrates a double-layer plastic object obtained with the devices according to FIGS. 16 and 17.

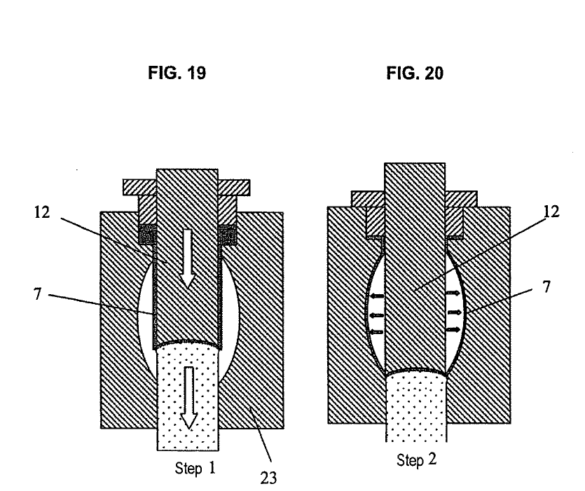

FIGS. 19 to 20 illustrate the manufacture of a plastic object of complex geometry. This object is manufactured in a first step (FIG. 19) using a technique identical to that illustrated in FIGS. 10 to 15, and in a second step (FIG. 20) where the object is deformed by injection of a gas or a liquid between the layer 7 and the wall of the upper piston 12 so as to press the layer 7 against the inner wall of the hollow body 23.

The deformation by inflation, illustrated in FIG. 20, can be carried out at a temperature higher than the melting point of the thermoplastic polymer. In this case, objects similar to those obtained by extrusion blow-moulding may be obtained. This technology, for example, makes it possible to produce objects made of PE or PP.

Alternatively, the deformation by inflation, as illustrated in FIG. 20, may be carried out at the biaxial orientation temperature of the polymer, that is to say after partial cooling of the object. Biaxial stretching may be obtained by combining axial stretching created by movement of the piston with the inflation. By way of example, objects made of PET or PP may be obtained.

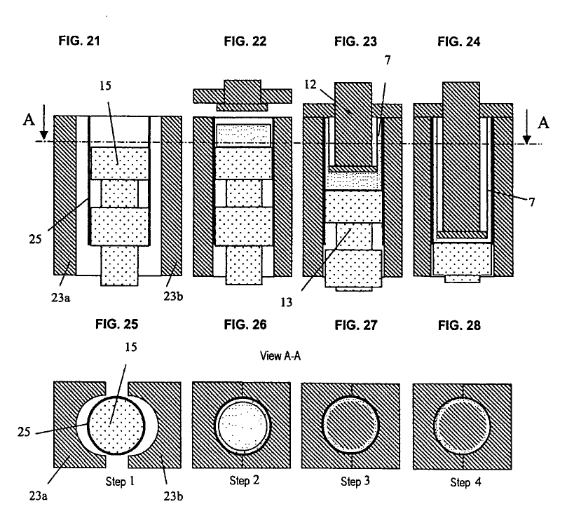

FIGS. 21 to 28 illustrate the manufacture by inner coating of a multiple material hollow plastic object (glass-plastic, aluminium-plastic, paper-plastic, plastic-plastic, etc.). The principle illustrated in FIGS. 21 to 28 may also be used to manufacture multilayer plastic objects.

FIG. 21 illustrates the position of the first material 25 on the outer surface of the tubular body 23. In fact, the tubular body 23 is not essential, it is mainly used if the first material 25 is flexible or fragile (for example, a film).

FIG. 25 shows a view in section along A-A of FIG. 21. FIG. 25 shows that the tubular body 23 is open so as to facilitate positioning the first material 25.

FIG. 22 shows the plastic 8 being fed into the device, together with the descent of the upper piston 12 and the closure of the lid 20.

FIG. 26 shows a view in section along A-A of FIG. 22.

FIG. 23 shows the formation of the layer 7 on the inner surface of the first material 25 on descent of the upper piston 12.

FIG. 27 shows a view in section along A-A of FIG. 23.

FIG. 24 illustrates the formation of the end of the object by compression of the material to be coated between the pistons 12, 13.

FIG. 28 shows a view in section along A-A of FIG. 24.

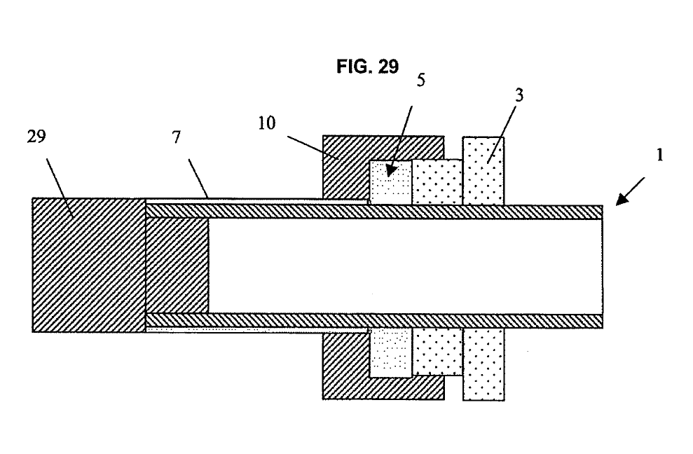

FIG. 29 illustrates the outer coating of an oblong object 1. A part 29 makes it possible to keep the object 1 oblong. Two parts 3, 10, one fitting into the other, form the cavity 5 in which the plastic 8 is found. The relative movement of the parts 3, 10 and of the oblong object 1 creates the deposition 7 of the plastic 8 over the outer surface of the oblong object 1.

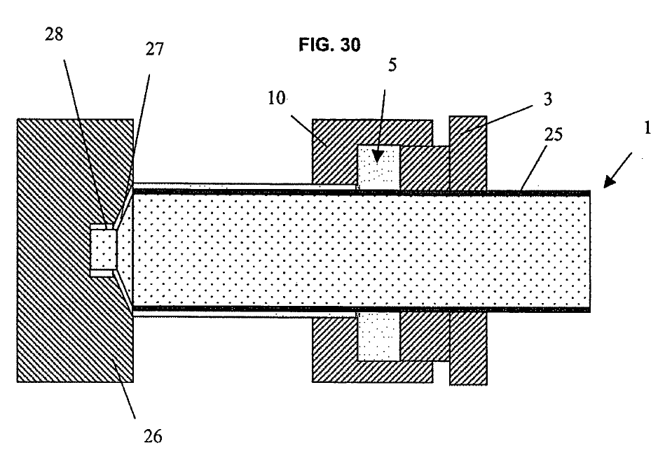

FIG. 30 illustrates the manufacture of a multiple-material tube with an outer coating device. A first material 25 is positioned. The head of the tube 28 is formed by compressing the material between the body 1 and a mould 26.

FIG. 31 illustrates the manufacture of a tube made of plastic with an inner coating device. The head of the tube 28 and the shoulder 27 are formed by compressing the plastic between the ends 30, 31 of two pistons 12, 13.

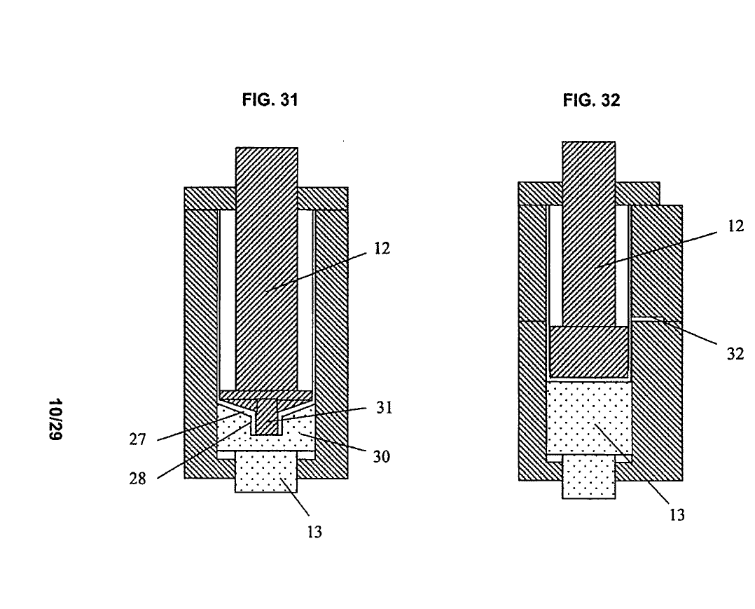

FIG. 32 illustrates the manufacture of an object made of plastic having a protuberance perpendicular to the coating. The cavity 32 forming the protuberance is filled when the plastic 8 contained between the pistons 12, 13 passes therethrough. The relative movement of the pistons 12, 13 makes it possible to adjust the pressure as the cavity forming the protuberance is filled.

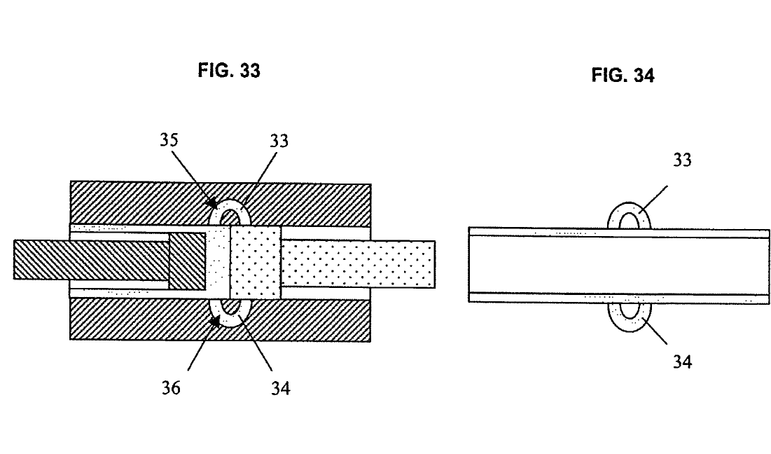

FIGS. 33 and 34 illustrate the manufacture by inner coating of a plastic tube with two side fastening lugs 33, 34.

FIG. 33 shows the formation of the coating and the filling of the side cavity 35, 36 by compression of the material contained between the pistons 12, 13.

FIG. 34 shows the plastic object obtained.

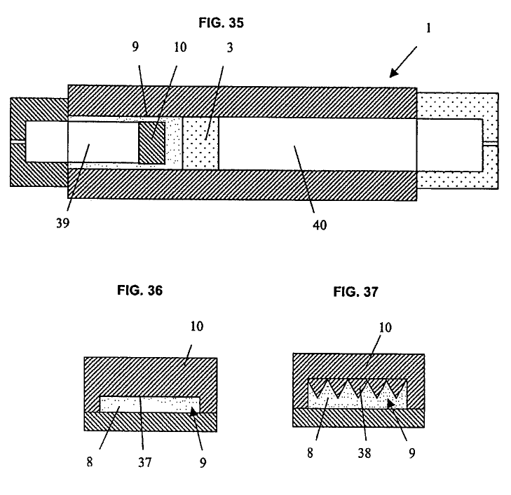

FIG. 35 illustrates an inner coating device, according to which the movement of two parts 3, 10 inside the cavity formed by the part 1 to be coated is created by the pressure of a liquid or of a gas in cavities 39, 40 adjacent to the reservoir 2. The pressure in the left cavity 39 is greater than the pressure in the right cavity 40 so as to move the part from left to right and to form the layer 7.

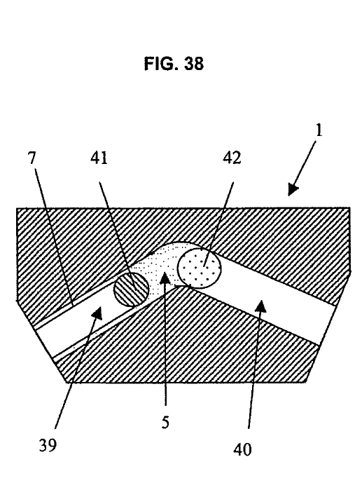

FIGS. 36 to 37 illustrate the fact that the geometry of the passage 9 can be adapted so as to obtain a layer 7 of constant or variable thickness.

FIG. 36 illustrates the geometry of an opening leading to a layer 7 of constant thickness.

FIG. 37 illustrates the geometry of an opening leading to a layer 7, the upper face 38 of which has grooves.

FIG. 38 illustrates a device for inner coating of a curved piece in which the moveable walls 41, 42 delimiting the cavity 5 containing the plastic 8 are spherical in shape, the movement of the spherical walls being achieved by injection of a gas or of a liquid into a cavity 39 adjacent to the reservoir 2.

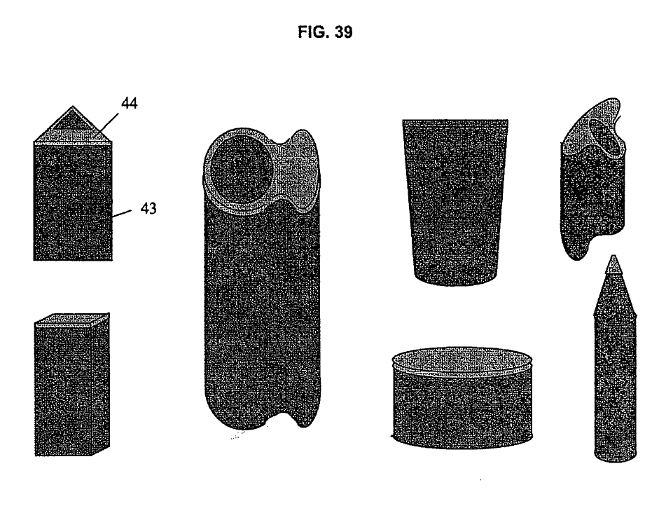

FIG. 39 illustrates the geometries of plastic objects which can be obtained with the coating device. The main part 43 of the object is manufactured with the device according to the invention. The upper part 44 of the object is manufactured independently and attached to the main part 43.

In some cases, it is possible to manufacture the main part and the upper part of the object in one step in the coating device.

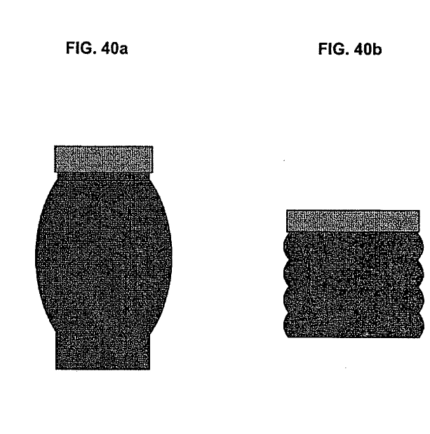

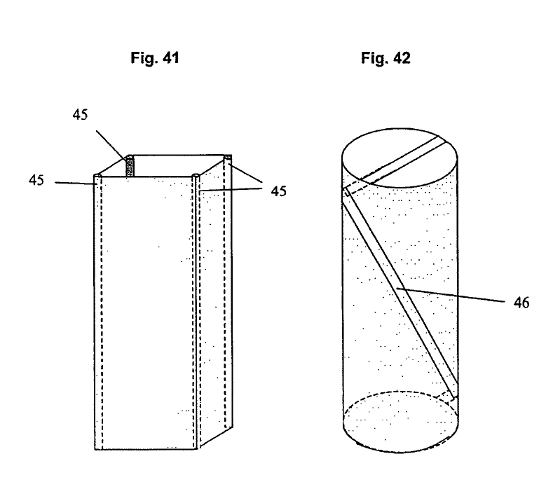

FIGS. 40a and 40b illustrate the geometries of plastic objects which can be obtained using the variant of the method described in FIGS. 19 and 20.

FIGS. 41 and 42 show objects produced according to the invention whose wall thickness is not uniform.

FIG. 41 shows an object made of plastic having walls which are thicker in the corners 45 making it possible to stiffen the part.

FIG. 42 shows a packaging made of plastic having a decreasing wall thickness along a spiral 46. The decrease in thickness may be used to facilitate the opening or the compacting of the packagings at the end of their life.

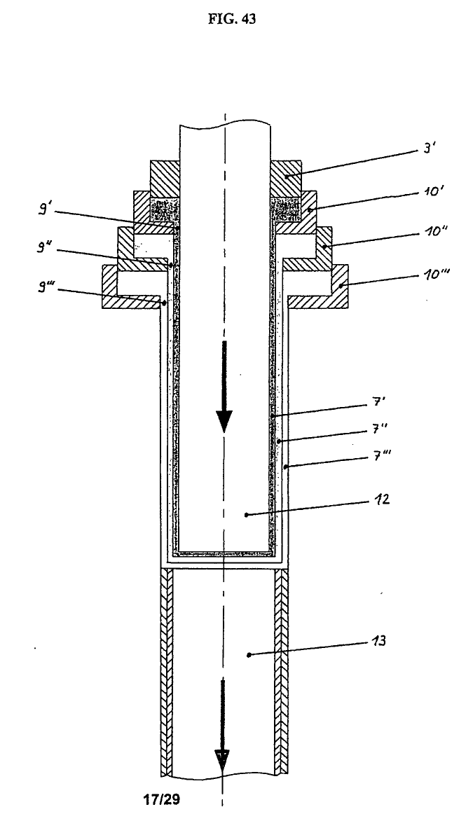

FIG. 43 illustrates the production of a multilayer coating, the various layers being deposited simultaneously. The coating device consists of walls 10′, 10″, 10′″ adjacent to the passages 9, 9″, 9′″ each moving relative to the others and of the pistons 12, 13. The multilayer coating is deposited on the surface of a piston 12.

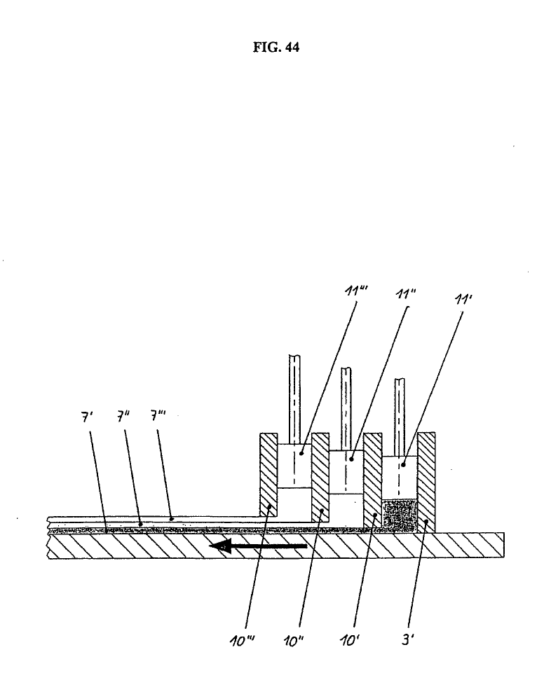

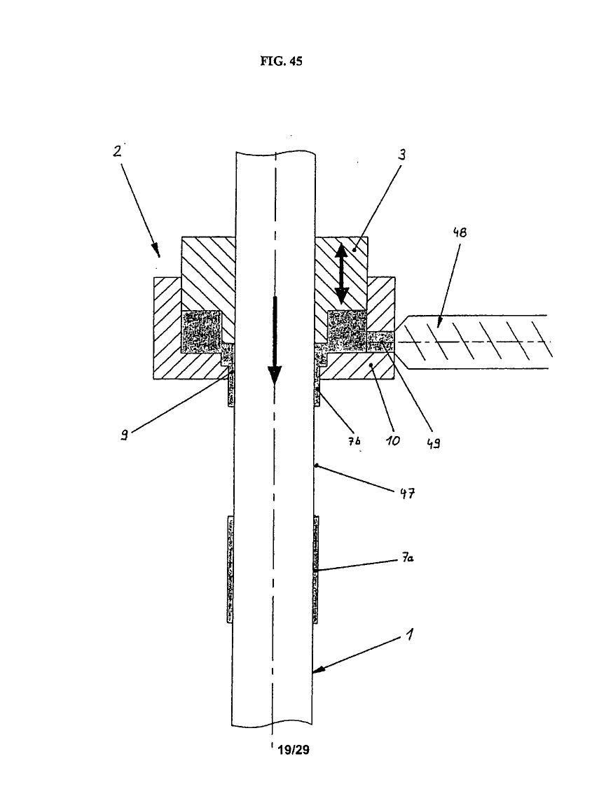

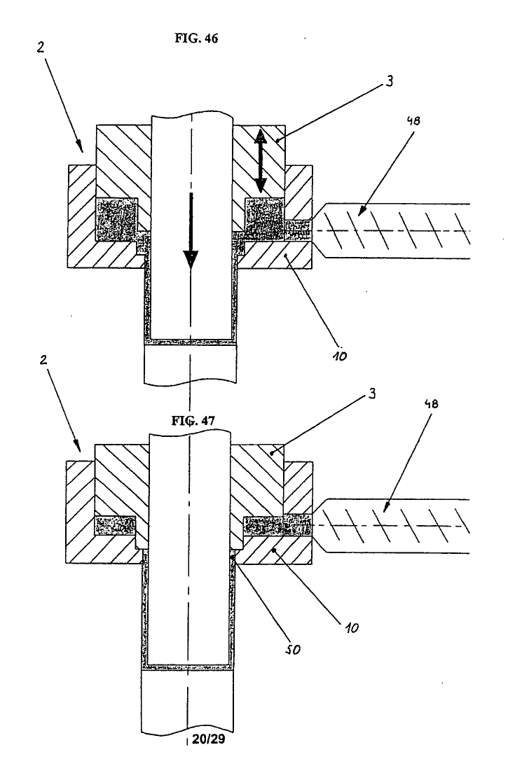

FIG. 44 illustrates the production of a multilayer coating simultaneously over the surface of the part 1, the compositions being pressurized respectively by the movement of the walls 11′, 11″, 11′″.

FIG. 45 shows an outer coating device making it possible to produce a discontinuous coating 7a, 47, 7b of the part 1. An extruder 48 feeds the reservoir 2 with plastic. The opening-closing movement of the reservoir 2 creates the discontinuous coating 7a, 47, 7b.

FIGS. 46 and 47 illustrate the production of plastic objects using an outer coating device. An extrusion system 48 feeds the reservoir 2 with plastic for coating. FIG. 47 shows the production of the end 50 of the object; as the wall 3 moves, it comes into contact in a sealed manner with the wall 10 adjacent to the passage and isolates the plastic from the end 50 of the object.

As has been seen, FIGS. 45, 46 and 47 describe an outer coating device fitted with a shutter making it possible to obtain a discontinuous coating.

Other types of shutters, for example of the cutting type, positioned outside the reservoir and preferably at the outlet of the reservoir, can also be provided. In the open position, the shutter does not interfere with the coating and allows the material to flow freely out of the reservoir.

When it is closed, the shutter stops the flow from the reservoir and may also serve to cut the coating and form the upper end of the part.

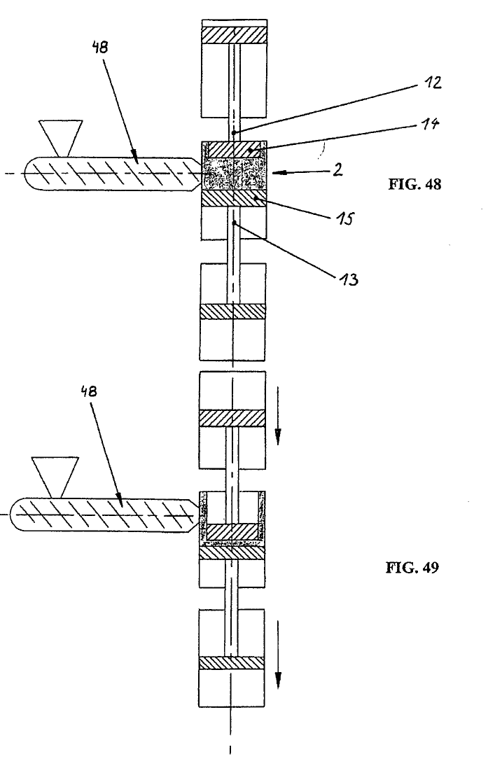

FIGS. 48 and 49 illustrate the plastic being fed into a coating device by an injection moulding machine or a discontinuous extrusion system 48. FIG. 48 illustrates the reservoir 2 of the coating device being filled. FIG. 49 shows the production of the object.

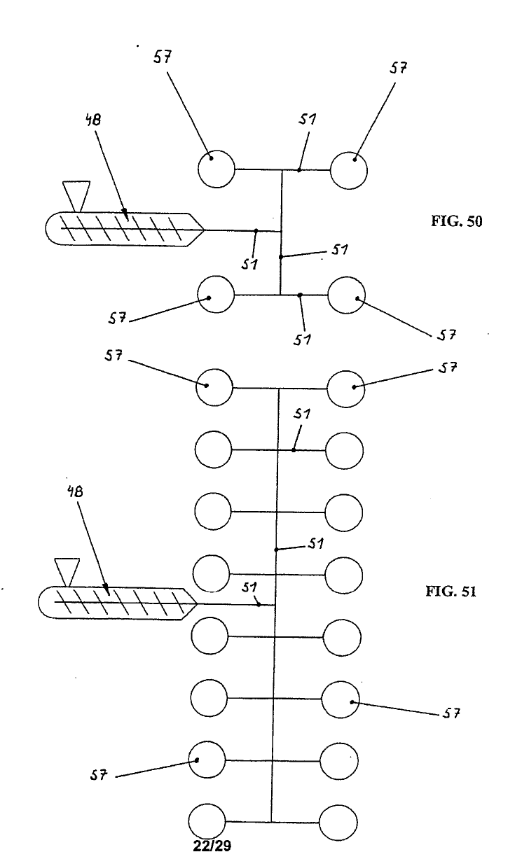

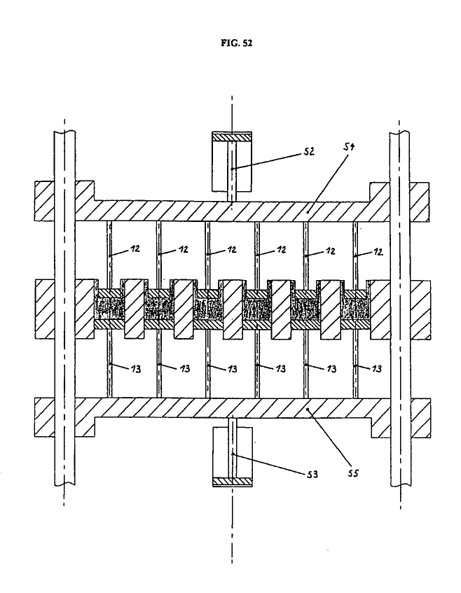

FIGS. 50 and 51 show, in a very simplified manner, several coating devices 57 fed by a single feed device 48. The plastic may be fed via hot channels from the extrusion system to the coating devices 57. Closing nozzles may be used. FIG. 50 shows four coating devices being fed using an injection moulding machine 48 and feed channels 51. FIG. 51 illustrates sixteen coating devices 57 being fed with an injection moulding machine 48 and feed channels 51.

FIG. 52 shows eight coating devices 57 in parallel actuated by the same system 52-55 diagrammatically represented.

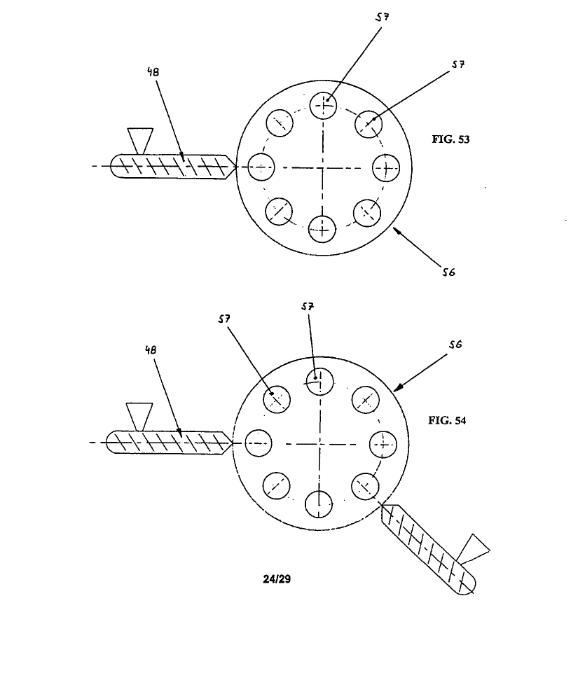

FIGS. 53 and 54 illustrate a sequential manufacturing process. The coating devices 57 are placed on a rotary device 56 of carousel type. An extrusion system 48 feeds the molten plastic into the coating devices 57. FIG. 54 illustrates the production of plastic objects made from several plastics.

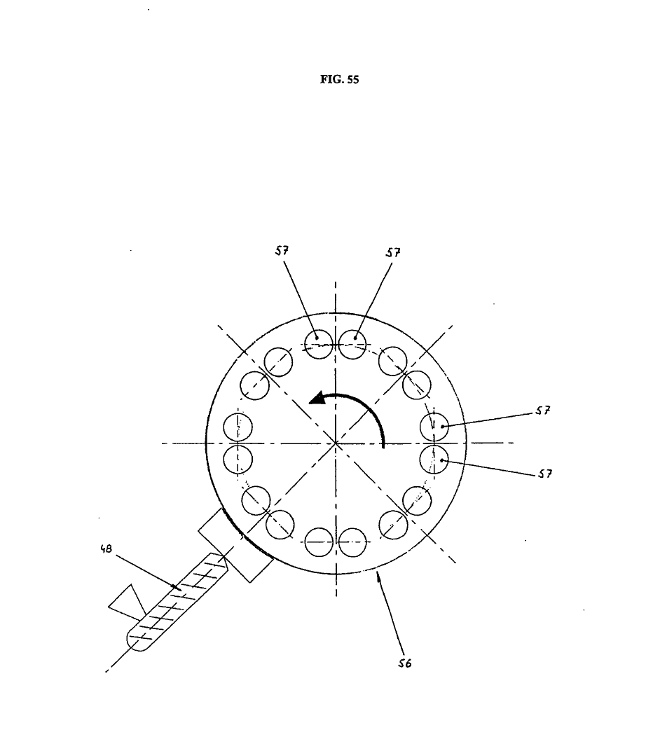

FIG. 55 shows eight groups of two coating devices 57 mounted on a carousel 56. In each group, the devices are actuated in parallel. The groups are actuated sequentially.

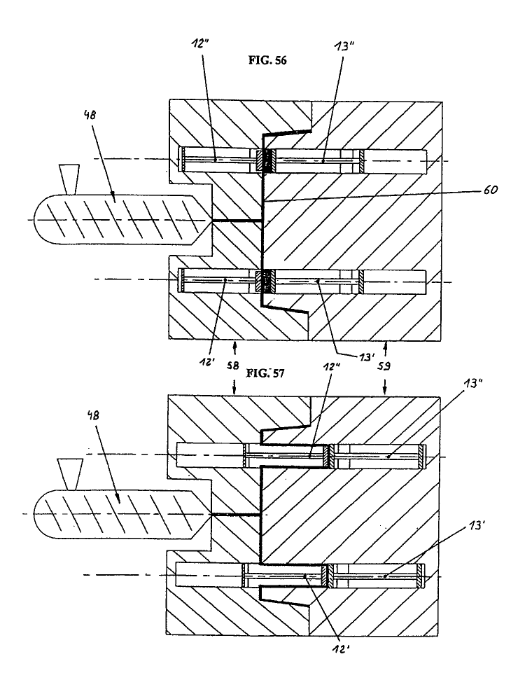

FIGS. 56 and 57 illustrate the combination of the method of injection and of coating by compression. The coating devices are placed in the mould 58, 59 forming a cavity 60. FIG. 56 shows the cavity of the mould 58, 59 being filled with the injection moulding machine 48. The reservoirs 2 of the coating devices form part of the cavity 60. FIG. 57 illustrates the formation of tubular elements of the object to be constructed, it being possible for the latter to form, for example, part of a table. The object thus manufactured comprises at least one part produced according to the invention. The combination of the injection method and of the coating method according to the invention is particularly beneficial for decreasing the injection pressures, and for manufacturing complex parts with thin walls.

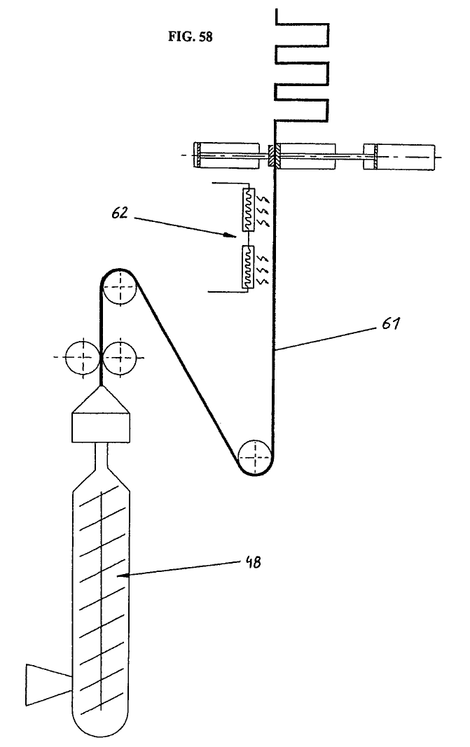

FIG. 58 illustrates the combination of the extrusion method and of the coating method as described in the invention. An extruder 48 makes it possible to manufacture a sheet 61 according to the conventional flat extrusion methods; a device makes it possible to transform the continuous running past of the sheet 61 into a discontinuous forward movement; a heater 62 makes it possible to heat the sheet 61 to the coating temperature according to the invention. This method makes it possible, for example, to produce objects of reservoir type having a constant wall thickness and great depth. Very thin side walls can be obtained.

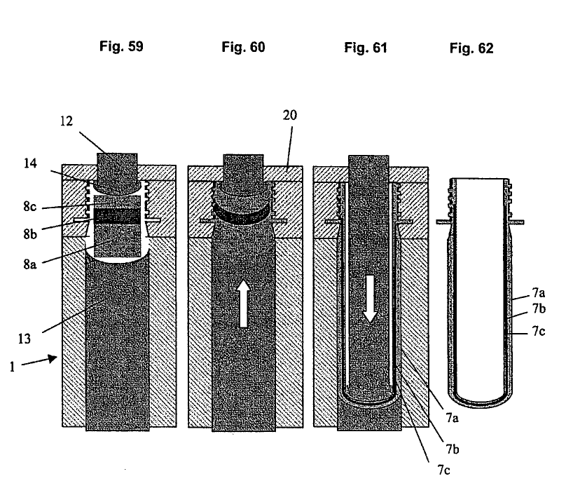

FIGS. 59 to 62 show the manufacture by inner coating of a multilayer object, from a multilayer disc fed into the reservoir.

FIG. 59 illustrates materials 8a, 8b and 8c being fed into the reservoir so as to form a multilayer disc. One option for forming the multilayer disc is successively to feed materials 8a, 8b and 8c into the reservoir. Another solution would be to form beforehand the multilayer dose and to feed it into the reservoir.

FIG. 60 shows the lower piston 13 rising in order to pressurize the material in the reservoir and to form the upper part of the object by compression. The lid 20 makes it possible to obtain a suitably closed reservoir 2.

FIG. 61 illustrates the descent of the piston 12, and the respective deformations of the materials 8a, 8b and 8c forming the coating 7 on the inner surface of the tubular body 1. The coating 7 consists of layers 7a, 7b and 7c corresponding respectively to materials 8a, 8b and 8c fed into the reservoir.

FIG. 62 shows the multilayer part obtained. The material 8a fed first into the reservoir is on the outer surface of the finished part, and the material 8c fed last is on the inner face of the object. Note that objects having more than three layers can be obtained.

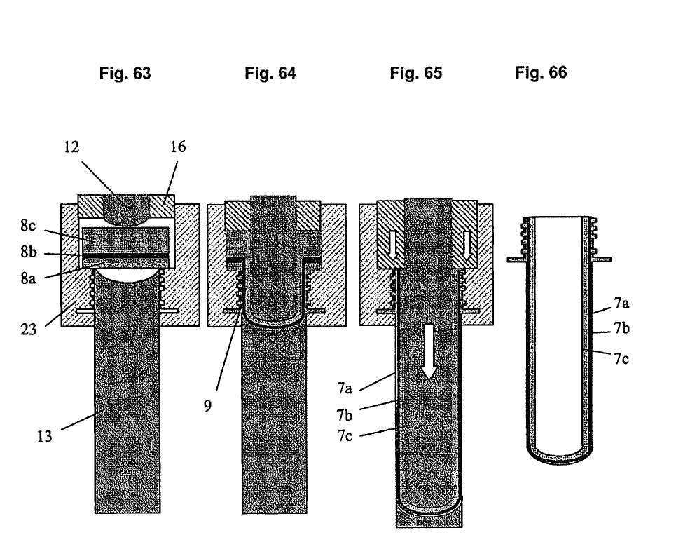

FIGS. 63 to 66 show an example of producing a multilayer object from a multilayer disc fed into an outer coating device.

FIG. 63 shows materials 8a, 8b and 8c being fed into the reservoir in order to form a multilayer disc.

FIG. 64 illustrates the pressurization of the materials in the reservoir, pressurization caused by the descent of the piston 12, and the pressure exerted by the annular piston 16. FIG. 64 shows the formation of the first part of the object around the end of the upper piston 12.

FIG. 65 shows the formation of the coating 7 consisting of layers 7a, 7b and 7c corresponding respectively to the materials 8a, 8b and 8c.

FIG. 66 shows the multilayer object obtained. The material 8a initially fed into the reservoir is on the outer surface of the finished part, and the material 8c fed last is on the inner face of the object. Note that objects having more than three layers can be obtained.

List of Numerical References

1. Part to be coated
2. Reservoir
3. First wall of reservoir
4. Second wall of reservoir
5. Reservoir cavity
6. Surface to be coated
7. Layer of plastic
8. Plastic in the liquid or viscous state
9. Passage
10. Reservoir wall adjacent to the passage
11. Moveable wall
12. First piston
13. Second piston
14. End of first piston
15. End of second piston
16. Annular piston
17. Lower face of annular piston
18. Narrow region
19. Collar
20. Lid
21. Upper end of an object or of a coating
22. Bottom of a hollow object
23. Hollow body
24. Replacement piston
25. Tubular object
26. Mould
27. Tube shoulder
28. Tube head
29. Holding part
30. End of lower piston
31. End of upper piston
32. Cavity for protuberance
33. Side fastening lug
34. Side fastening lug
35. Side cavity
36. Side cavity
37. Upper wall of passage
38. Upper wall of passage
39. Cavity for propellant fluid
40. Cavity for control fluid
41. Spherical moveable wall
42. Spherical moveable wall
43. Main part of object
44. Upper part of object
45. Rigid element
46 Rigid element
47. Coating discontinuity
48. Injection moulding machine/Plastic extruder
49. Plastic injection orifice
50. Upper end of object
51. Feed channel
52. Piston
53. Piston
54. End of piston
55. End of piston
56. Carousel
57. Coating device
58. Half mould
59. Half mould
60. Mould cavity
61. Sheet of plastic
62. Heater

1. Method of manufacturing a layer (7) over a surface (6) from a liquid or viscous plastic (8) which solidifies once the layer (7) is formed, characterized in that the plastic (8) is introduced in liquid or viscous form into a reservoir (2) of variable volume, at least part of the inner wall of which is defined by a portion of the said surface (6); the reservoir (2) and the surface (6) are moved relative to each other while simultaneously decreasing the volume of the reservoir (2) so as to compress the plastic (8) and make it flow through a passage (9) connecting two surface portions placed respectively inside and outside the reservoir (2), the rate of flow of the plastic (8) through the passage (9) being chosen so as to form a layer (7) over one of the said surface portions (6) whose thickness (e) is less than the height of the said passage (E).

2. Method according to claim 1, characterized in that the surface (6) is stationary and that the reservoir (2) is moved.

3. Method according to claim 1, characterized in that the reservoir (2) is stationary and that the surface (6) is moved.

4. Method according to claim 1, characterized in that the plastic layer (7) is deposited over the inner wall of a hollow body (1), the reservoir (2) being defined by the ends (14, 15) of two pistons (12, 13) facing each other and sliding in the hollow body (1) and by a portion of the inner wall of the hollow body (1).

5. Method according to claim 1 for manufacturing a coating over the inner wall of a hollow body (1), characterized in that the layer is attached to the inner wall of the hollow body (1).

6. Method according to claim 4 for manufacturing a tubular element, characterized in that after having been formed, the layer (7) is separated from the tubular body (1).

7. Method according to claim 1, characterized in that the plastic layer (7) is deposited on the outer wall of a tubular body (1, 12) by means of a reservoir (2) surrounding an annular portion of the outer wall and sliding relative to the tubular body (1, 12).

8. Method according to claim 1, characterized in that after having deposited the layer (7), a fluid is injected between the layer (7) and the outer wall of the tubular body (1, 12) in order to separate and move the layer (7) away from the tubular body (1, 12).

9. Method according to claim 1, characterized in that plastic (8) is injected into the reservoir (2) during its relative movement and in that its volume is increased before or at the same time as depositing the plastic (8).

10. Method according to claim 1, used in combination with a method of manufacturing at least one layer by compression moulding.

11. Method according to claim 1, used in combination with a method of manufacturing at least one layer by injection moulding.

12. Method according to claim 1, used in combination with a method of manufacturing at least one layer by extrusion moulding.

13. Device for manufacturing a layer over a surface operating according to the method described in claim 1, characterized in that it comprises:
a surface to be coated (6),
a reservoir (2) of variable volume, at least part of the inner wall of which is defined by a portion of the said surface (6),
a passage (9) connecting two portions of the surface (6) that are placed respectively inside and outside the reservoir (2), the height (E) of the passage constituting an upper limit of the thickness (e) of a layer (7) to be deposited,
means (12, 13) for producing relative movement of the reservoir (2) with respect to the surface (6),
means (10) for decreasing the volume of the reservoir (2) during its relative movement.

14. Device according to claim 1, combined with a device for manufacturing at least one layer by compression moulding.

15. Device according to claim 13, combined with a device for manufacturing at least one layer by injection moulding.

16. Device according to claim 13, combined with a device for manufacturing at least one layer by extrusion moulding.

17. Device according to claim 13, further comprising means (48) for injecting the plastic.

18. Device according to claim 13, characterized in that the surface (6) is stationary and the reservoir (2) is moveable.

19. Device according to claim 13, characterized in that the surface (6) is moveable and the reservoir (2) is stationary.

20. Device according to claim 13, characterized in that the reservoir (2) is defined by the inner wall of a hollow body (1, 23) and by the ends (14, 15, 17) of two pistons (12, 13, 16) facing each other and sliding in the hollow body (1, 23).

21. Device according to claim 13, comprising means for injecting a fluid between the layer (7) and the surface to be coated (6) so as to separate the layer (7) from the surface (6) to be coated.

22. Device according to claim 13, comprising means (48) for injecting plastic into the variable volume reservoir.

23. Device according to claim 13, comprising a plurality of variable volume reservoirs (2) placed sequentially along the surface (6) to be coated.

24. Device according to claim 13, comprising a plurality of variable volume reservoirs (2) arranged adjacent to each other.

25. Device according to claim 13, characterized in that the surface (6) to be coated comprises a cavity intended to accommodate plastic (8)

26. Set of devices as described in claim 13, characterized in that the said devices are put in communication with a plastic feed device (48).

27. Set of devices as described in claim 13, characterized in that the said devices are activated by the same system (52-55).

28. Set of devices as described in claim 13, characterized in that the said devices are part of a rotating system (56) which makes it possible for each object to be treated sequentially.

29. Object obtained according to the method described in claim 1, characterized in that it comprises a layer consisting of a plastic which was initially liquid or viscous and which solidified once it was deposited, the inner and outer faces of the layer having different roughnesses.

30. Object according to claim 29, comprising a variable thickness layer.

31. Object according to claim 29, characterized in that it comprises at least one plastic protuberance along one of its walls.
